(19) United States
(12) Patent Application Publication
(10) Pub. No.: US 2017/0032094 A1
(43) Pub. Date: Feb. 2, 2017

(54) APPARATUS, METHOD, AND MEDIUM FOR AIDING SUCCESSFUL OUTPATIENT ORTHOPEDIC SURGERY

(71) Applicants: Robert Michael Meneghini, Fishers, IN (US); Peter Caccavallo, Fishers, IN (US)

(72) Inventors: Robert Michael Meneghini, Fishers, IN (US); Peter Caccavallo, Fishers, IN (US)

(21) Appl. No.: 14/814,696

(22) Filed: Jul. 31, 2015

(51) Int. Cl. G06F 19/00

(52) U.S. Cl. CPC G06F 19/3437; G06F 19/3481; G06F 19/328; G06F 19/3487

(57) ABSTRACT

An apparatus for aiding successful outpatient orthopedic surgery includes a communication interface, a memory, and a processor. The memory stores data representative of a plurality of physiological characteristics that are considered in determining suitability of a patient for outpatient orthopedic surgery, and further stores data representative of a plurality of associated weighted values. Each associated weighted value corresponds to a respective physiological characteristic. The processor determines whether a particular patient is suitable for outpatient orthopedic surgery by calculating a suitability value based on one or more identified weighted values, from among the plurality of associated weighted values, corresponding to one or more identified physiological characteristics which the particular patient exhibits. The suitability value is compared with one or more predetermined standard values related to suitability of a patient for outpatient orthopedic surgery.

### TECHNICAL FIELD

The technical field relates in general to an apparatus for aiding a physician in successfully performing an outpatient orthopedic surgery. Specifically, the apparatus measures suitability of an orthopedic surgery candidate to have the surgery performed in an outpatient setting.

### BACKGROUND

Healthcare reform, along with patient demands for faster recovery, have contributed to an interest and desire to move motivated and medically low-risk orthopedic surgery patients from an inpatient setting into an outpatient ambulatory surgery setting. The key to safe and effective transition of the orthopedic surgery patient from the inpatient setting to the outpatient setting is selecting the appropriate patient. Of course successful outpatient orthopedic surgery includes optimizing the patient's peri-operative medical care and pain control through a formalized coordination of care.

The present application describes a novel and unique apparatus, method, and medium for using selection characteristics as applied to a particular orthopedic surgery patient to determine suitability of the patient for surgery in an outpatient setting. An outpatient-based total joint replacement program or orthopedic surgery program can be developed based around the inventive concepts as a building block. Greater patient safety, a patient-centered experience, and optimal outcomes will thereby be obtained.

### SUMMARY

Accordingly, one or more embodiments provide an apparatus, configured as a node on a network. The apparatus comprises a communication interface, a memory, and a processor. The memory stores data representative of a plurality of physiological characteristics that are considered in determining suitability of a patient for outpatient orthopedic surgery, and further stores data representative of a plurality of associated weighted values, each associated weighted value corresponding to a respective physiological characteristic from the plurality of physical characteristics.

The processor is cooperatively operable with the memory and the communication interface. The processor determines whether a particular patient is suitable for outpatient orthopedic surgery. The processor does this by performing various functions.

The various functions include calculating a suitability value based on one or more identified weighted values from among the plurality of associated weighted values, the identified weighted values corresponding to one or more identified physiological characteristics from among the plurality of physiological characteristics, which the particular patient exhibits. The various functions further include comparing the suitability value with one or more predetermined standard values related to suitability of a patient for outpatient orthopedic surgery.

A further embodiment claimed herein relates to a method that recites features similar to those described above, related to the claimed apparatus. As well, a non-transitory computer readable storage medium is claimed that stores instructions such that the method is executed by an apparatus.

The purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating an outpatient orthopedic surgery aiding system, including an outpatient orthopedic surgery aiding server.

FIG. 2 is a diagram illustrating a physician using an outpatient orthopedic surgery aiding server.

FIG. 3 is a block diagram illustrating an outpatient orthopedic surgery aiding server configured to implement outpatient orthopedic surgery aiding functionality.

FIG. 4 is a flow chart illustrating an outpatient orthopedic surgery aiding method.

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented in a processor, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

The present disclosure presents embodiments for aiding successful outpatient orthopedic surgery. More particularly, by analyzing a variety of physiological characteristics of a particular patient in view of established standards, a physician can more accurately determine whether an orthopedic surgery patient is an optimal candidate to have the surgery performed in an outpatient setting.

This disclosure presents several acronyms and/or abbreviations that are known to medical practitioners. The following list presents the meanings of these acronyms to facilitate understanding by lay readers and/or the public generally:
A1C Glycated Hemoglobin
ACC American College of Cardiology
ADL Activity of Daily Living
AHA American Heart Association
ASC Ambulatory Surgical Center
AV Aortic Valve
BID Bis in Die (Twice a Day)
BM Bowel Movement
BMI Body Mass Index
BMP Basic Metabolic Panel
BP Blood Pressure
BPH Benign Prostatic Hyperplasia/Hypertrophy
CABG Coronary Artery Bypass Grafting
CAD Coronary Artery Disease
COPD Chronic Obstructive Pulmonary Disease
DBP Diastolic Blood Pressure
DVT Deep Venous Thrombosis
ER Emergency Room
EQ5D EuroQol Group Self-Completed Test (Health Outcome)
GFR Glomerular Filtration Rate
GI Gastrointestinal
GU Genitourinary
H2 Histamine Receptor (Type Of)
H&P History & Physical
HG Hemoglobin
HGB Hemoglobin
H/O History Of
HTN Hypertension
IM Intramedullary
IV Intravenous/Intravenously
IVF Intravenous Fluid
LV Left Ventricular
MD Medical Doctor
MELD Model for End-Stage Liver Disease
MG Milligrams
MI Myocardial Infarction
MMSE Mini-Mental State Examination
NC Nasal Cannula (Device)
NEURO/PSYCH Neurological/Psychological
NS Normal Saline
NYHA New York Heart Association
OSA Obstructive Sleep Apnea
ORTHO Orthopaedic (Surgery)
OT Occupational Therapy
PACU Postoperative Acute Care Unit
PE Pulmonary Embolism
PO Per Orem (Orally)
POD Post-Operative Day
POST-OP Post-Operative
PPI Proton-Pump Inhibitor
PRN Pro Re Nata (When Necessary)
PTCA Percutaneous Transluminal Coronary Angioplasty
Q Every
RA Room Air
RN Registered Nurse
RR Respiratory Rate
SATS Oxygen Saturation
SBP Systolic Blood Pressure
SCD Sequential Compression Device
SOB Shortness of Breath
SUBQ Subcutaneous
TKA Total Knee Arthroplasty
TID Ter in Die (Three Times a Day)
UCLA University of California—Los Angeles
UTI Urinary Tract Infection
URI Upper Respiratory Infection
WNL Within Normal Limits
WOMAC Western Ontario and McMaster Universities Osteoarthritis Index
XA Factor XA

I. Orthopedic Perioperative Considerations/Recommendations

In order for the orthopedic surgery patient to be safe, comfortable, and able to be discharged home after outpatient orthopedic surgery, an orthopedic surgeon must ensure a reliable and reproducible perioperative surgical environment that is supportive of expedited recovery and early discharge.

Of course, each orthopedic surgeon MUST examine his/her own surgical experience and skill to ensure he/she is capable of enacting an efficient and safe orthopedic surgery procedure in a reproducible, efficient, and safe manner. This includes an assurance of predictably minimizing surgical trauma and blood loss during the procedure. A critical component of the process is the pre-operative patient selection criteria that will ensure an early recovery, attained through minimizing blood loss, soft-tissue trauma and painful inflammation.

The following criteria should be followed and may be modified by the surgeon's own judgment, experience and surgical ability:

A. Preoperative Selection Criteria/Recommendations
Age less than 65 with active lifestyle and pre-operative activity level
Body-Mass-Index less than 40
Motivated to have joint replacement in the outpatient setting
Adequate family support and motivated to recover at home
Must be willing to attend a pre-operative educational class
Able to ambulate independently preoperatively without assist device
Anticipated and predictable surgery less than 120 minutes duration
Minimal peri-articular deformity
Minimal, if any, peri-articular bone loss
Minimal, if any, existing hardware that will require removal
No pre-exiting arthroplasty implants
Straight-forward soft-tissue envelope, without complicating previous incisions

B. Intraoperative Recommendations
Avoidance of intrathecal narcotic
Surgical time less than 120 minutes
Topical or Intravenous Tranexamic Acid
Consider Navigation and avoidance of IM Canal perforation in TKA
Peri-articular anesthetic injection in TKA
SubQ closure with Dermabond or equivalent skin sealant
Aquacell or similar Dressing

C. Postoperative Protocol
Call from perioperative medical specialist evening of discharge
Call from orthopedic surgeon evening of discharge
Call from perioperative medical specialist next day after discharge
Call from orthopedic surgeon next day after discharge
Home health visit day of discharge or a minimum next day after discharge if total knee arthroplasty
Communication by home health RN to surgeon team—critical

II. Anesthesia Perioperative Recommendations

In conducting outpatient orthopedic surgery, emphasis is placed on optimizing perioperative pain control and expediting rapid recovery through minimizing anesthesia side effects that might prolong recovery or length of stay. Consistent and frequent communication to develop the optimal anesthetic protocols is mandatory. This partnership and collaboration involves the surgeon and anesthesia and perioperative medicine physicians. A focus is placed on determining the balance between 1) optimizing pain control and 2) minimizing the side effects of anesthesia and pain medicines that could preclude a same day or next day surgery. In addition, the anesthesia and perioperative pain control modalities must facilitate and enable ambulation within a few hours of the surgical procedure completion.

The following basic principles should be considered:

A. Hips
Light general anesthetic
Single-dose spinal with bupivacaine and fentanyl
Avoidance of intrathecal morphine
Periarticular injection of ropivacaine and epinephrine if desired

B. Knees
Light general anesthetic
Consideration of single-dose spinal with bupivacaine and fentanyl
Adductor canal block
Avoidance of intrathecal morphine
Periarticular injection of ropivacaine and epinephrine

III. Internal Medicine Patient Selection Criteria

Patient selection is critical to enabling rapid recovery from outpatient orthopedic surgery including outpatient hip and knee replacement. Furthermore, with healthcare reform and increasing scrutiny placed on postoperative complications and readmissions, medical risk assessment of a potential outpatient orthopedic surgery candidate is the most important aspect of patient selection and ultimately will dictate the success of an outpatient orthopedic surgery program.

A quantitative outpatient risk assessment score has been developed which allows categorization of patients into low, moderate and high risk categories. Before discussing exactly how the categorization is achieved, an overview of the types of patients is provided.

A. Patient Types

There are two basic patient types: the ideal patient and the excluded patient. The excluded patient may be absolutely excluded or relatively excluded.

1. Ideal Patient
Motivated
   Reads preoperative information
   Does preoperative exercises
   Positive emotional and mental outlook
   Eager to return home and recover quickly
Insightful
   Understands expectations of pain
   Understands their medical history and medications
Still mobile and self-supporting preoperatively despite disability
Good home support with family and/or friends
Sees Primary Care MD regularly: Medical problems well controlled
Has undergone previous hip or knee arthroplasty (if applicable)

2. Medically Excluded Patient

A. Absolute Exclusion
Poor motivation
Tenuous cardiomyopathy
   H/O pulmonary edema
   ACC/AHA stage C or D
Decompensated coronary artery disease
   NYHA class III or IV
Severe deconditioning/debility/frailty/immobility
Severe Renal disease (GFR<30)
Moderate-to-severe memory disorder
Severe aortic stenosis
Significant liver disease
   Child-Turcotte-Pugh class C or MELD >15 cirrhosis
Uncontrolled Asthma
Uncontrolled COPD
Significant coagulopathy
A1c≧8.0 or lack of insight in controlling blood glucose
Non-compliance
   i.e. multiple uncontrolled medical problems
Baseline hyponatremia
   Sodium <130 units
Significant unevaluated anemia
   Hg<11.0 units

B. Relative Exclusion
Chronic narcotic use
History of pain control difficulty
Significant thrombophilic disease
Compensated cardiomyopathy
   H/O pulmonary edema
   ACC/AHA stage A or B
Compensated coronary artery disease
   NYHA class I or II
Excessive steroid use
Uncontrolled depression
Lack of home social support
Moderate aortic stenosis
Uncontrolled diabetes (A1c 7.0-7.9)
Type 1 diabetics (varies on fragility)
Intrathecal narcotics
Previous post-op ileus
Mild memory disorder

IV. Risk Assessment

Through assimilation and experience in the perioperative medical care of thousands of hip and knee patients, a scoring system has been developed (sometimes known as Outpatient Arthroplasty Risk Assessment [“OARA”] Score or Outpatient Orthopedic Risk Assessment [“OORA”] Score) to aid in determining which patients make strong candidates for outpatient surgery. By using the score, a physician is more likely to achieve a successful outpatient orthopedic surgery result.

The prior art, including the American Society of Anesthesiologists (ASA) Physical Status Classification System and the Charlston Comorbidity Index, lacks specificity and sensitivity in predicting a patient's perioperative medical risk in the outpatient orthopedic setting. The unique and novel risk assessment score disclosed herein represents a more detailed and specific risk-stratification tool to provide guidance and assurance when evaluating patients with regard to orthopedic surgery in an outpatient setting. The presently disclosed risk assessment stratifies the perioperative medical risk of the orthopedic surgery patient into one of three categories: low, moderate and high risk. The risk measured is of course the risk of perioperative medical complications. A low risk patient can generally safely undergo a hip or knee replacement in an outpatient or rapid recovery setting.

In the prior art, the underlying premise is that cumulative risk factors, or co-morbid medical conditions, elevate a patient to a higher category. The herein disclosed risk assessment scoring does not treat various risk factors as cumulative, and allows more patients to be considered appropriate candidates for outpatient orthopedic surgery with an assurance of safety. However, it should be emphasized that the preoperative and intraoperative recommendations discussed above, as well as further below, must be used in conjunction with the disclosed risk assessment scoring in order to minimize perioperative surgical stress on a patient, achieve optimal surgical outcomes, and avoid postoperative medical complications.

The risk assessment score quantifies risk as an assessment of appropriateness for outpatient or early discharge from orthopedic surgery including hip or knee replacement. The risk assessment score is not a predictor of intraoperative or surgical complication risk. Rather, the score is a predictor of success in an outpatient setting, indicating that it is more or less likely that complications will arise as a result of performing the surgery outside of an inpatient hospital setting.

In the current embodiment, a variety of physiological characteristics are stored in a memory of an apparatus implementing the risk assessment scoring. Each of the characteristics is a characteristic that should be given consideration in determining whether an orthopedic surgery patient should undergo the surgery in an outpatient setting. As one of ordinary skill in the art would understand, different characteristics have different weight. Generally speaking, the weight assigned to different characteristics is predetermined, but may be performed dynamically as well.

Each physiological characteristic is weighted according to a standard weight unit (SWU). A characteristic that is of minimal importance or represents minimal risk is typically represented by a single SWU. Characteristics that are of higher importance are weighted by multiple SWUs. An SWU is usually given by an integer, for example the number “5.”

Thus in considering outpatient orthopedic surgery, mild-to-moderate asymptomatic aortic stenosis is a physiological characteristic that does not represent a significant risk to patient considering outpatient orthopedic surgery. An associated weighted value of mild-to-moderate asymptomatic aortic stenosis would be a single (1) SWU, rendering the associated weighted value as 5. In contrast, severe asymptomatic aortic stenosis (with an AV area <1.0) is a physiological characteristic that indeed represents a significant risk to a patient considering outpatient orthopedic surgery. Therefore, severe asymptomatic aortic stenosis is weighted at twelve (12) SWUs, rendering an associated weighted value at 60.

The following table presents a plurality of physiological characteristics that are used when performing a risk assessment of an orthopedic surgery patient for outpatient surgery. The physiological characteristics are further categorized according to general medical categories (general, hematological, cardiac, endocrine, GI, neuro/psych, renal/urology, pulmonary, and infectious diseases)

TABLE 1
Physiological Characteristics for Consideration in Outpatient Orthopedic Surgery

| Medical Risk Factor (by Group) | SWU | Weighted Score |
|---|---|---|
| A. General | | |
| BMI >40 | 3 | 15 |
| BMI >30-39 | 1 | 5 |
| Chronic narcotic use (>30 mg oxycodone equivalent per day) | 10 | 50 |
| Chronic pain control difficulty | 12 | 60 |
| Chronic benzodiazepine use (>1 mg alprazolam equivalent per day) | 10 | 50 |
| B. Hematological | | |
| Significant thrombophilic disease | 10 | 50 |
| Sickle Cell disease | 12 | 60 |
| Warfarin use without bridge requirement | 2 | 10 |
| Direct thrombin and factor Xa inhibitors | 10 | 50 |
| Plavix use | 1 | 5 |
| Chronic stable evaluated anemia Hg 11.0-normal | 6 | 30 |
| Chronic stable evaluated anemia Hg <11 | 12 | 60 |
| Unevaluated anemia | 12 | 60 |
| C. Cardiac | | |
| Baseline BP >180/110 | 12 | 60 |
| LV systolic dysfunction without H/O pulmonary edema | 6 | 30 |
| H/O pulmonary edema | 10 | 60 |
| Diastolic dysfunction Stage I-II | 1 | 5 |
| Diastolic dysfunction Stage III-IV | 6 | 30 |
| Stable CAD non-obstructive | 1 | 5 |
| Stable CAD with H/O MI/stent/PTCA/CABG | 2 | 10 |
| Mild-Moderate asymptomatic aortic stenosis | 1 | 5 |
| Severe asymptomatic aortic stenosis (AV area <1.0) | 12 | 60 |
| Pacemaker dependence | 6 | 30 |
| Severe pulmonary HTN | 12 | 60 |
| Moderate pulmonary HTN | 6 | 30 |
| D. Endocrine | | |
| Controlled diabetes (A1c <7.0) | 1 | 5 |
| Uncontrolled diabetes (A1c 7.0-7.9) | 6 | 30 |
| Uncontrolled diabetes (A1c >8.0) | 12 | 60 |
| Type 1 diabetics, brittle | 10 | 50 |
| Excessive steroid use (>20 mg/day over 3 weeks) | 4 | 20 |
| E. Gastro-Intestinal | | |
| H/O previous post-op ileus | 12 | 60 |
| Cirrhosis | 12 | 60 |
| Difficulty swallowing | 12 | 60 |
| Uncontrolled constipation | 1 | 5 |
| F. Neuro/Psych | | |
| Mild memory disorder (MMSE 25-30) | 6 | 30 |
| Moderate-to-severe memory disorder (MMSE <25) | 12 | 60 |
| Uncontrolled depression | 5 | 30 |
| H/O stroke | 1 | 5 |
| H/O postoperative confusion | 12 | 60 |
| G. Renal/Urology | | |
| Severe Renal disease (GFR <30) | 14 | 70 |
| Severe Renal disease (GFR 30-60) | 6 | 30 |
| H/O urinary retention | 10 | 60 |
| Severe BPH | 10 | 60 |
| H. Pulmonary | | |
| Uncontrolled Asthma (Symptoms >2/week) | 14 | 70 |
| Controlled Asthma | 1 | 5 |
| Asymptomatic COPD | 1 | 5 |
| Symptomatic COPD or daily bronchodilator use | 6 | 30 |
| Chronic hypoxemia | 6 | 50 |
| Untreated OSA | 12 | 60 |
| Snoring or excessive daytime sleepiness | 6 | 30 |
| I. Infectious Disease | | |
| Mild URI | 1 | 5 |
| Severe URI | 12 | 60 |

A suitability value can be can calculated based on identified physiological characteristics that a particular orthopedic surgery patient exhibits. That is to say, for each physiological characteristic that the particular patient exhibits, the weighted scored associated with the respective physiological characteristic is demarcated as an identified weighted value. Then a total score (a suitability value) is calculated based on the identified weighted values. In the present embodiment, a suitability value is calculated by summing the identified weighted values (as the suitability value). The sum is then compare with predetermined standard values to determine if that the orthopedic surgery patient is suitable for outpatient surgery.

In the present embodiment, the predetermined standard values may be used in the manner illustrated in Table 2. Specifically, the suitability value is compared with predetermined standard values as follows:

TABLE 2
Comparison with Predetermined Standard Values

| | Predetermined |
|---|---|
| Risk Categories | Value Comparison |
| Appropriate Outpatient Candidate (low risk) | ≦29 |
| Poor but Acceptable Outpatient Candidate | ≧30 and ≦59 |
| (moderate risk) | |
| Inappropriate Outpatient Candidate (high risk) | ≧60 |

It should be clear that in the present, exemplary embodiment, a patient exhibiting a single physiological characteristic might be an inappropriate candidate for outpatient orthopedic surgery. As an example then, assume a candidate patient for outpatient surgery has a history of postoperative confusion as a physiological characteristic (in the neuro/psych group). The weighted score of that characteristic alone (being 60) renders the patient an in appropriate candidate. On the other hand a candidate exhibiting both mild URI (weighted score 5) and excessive steroid use (weighted score 20) would still be an appropriate candidate for outpatient surgery as the suitability value of 25 is less than an initial predetermined valued of 29.

It should be expressly noted that the particular SWUs, weighted scores, and predetermined values used above are exemplary. Actual values in practice may be similar but certainly may be different as well. The exemplary values simply demonstrate inventive principles.

A slight modification that can be made is that each group of physiological characteristics (general, hematological, cardiac, endocrine, GI, neuro/psych, renal/urology, pulmonary, and infectious diseases) may be further weighted. For example, it might be considered that, as a whole, cardiac characteristics in general present more of a risk to a candidate outpatient orthopedic surgery patient than neuro/psych characteristics. In such a case it might be determined that physiological characteristics from a group deems as presenting overall lower risk might be further discounted by taking a product of any weighted scores by a percentage factor.

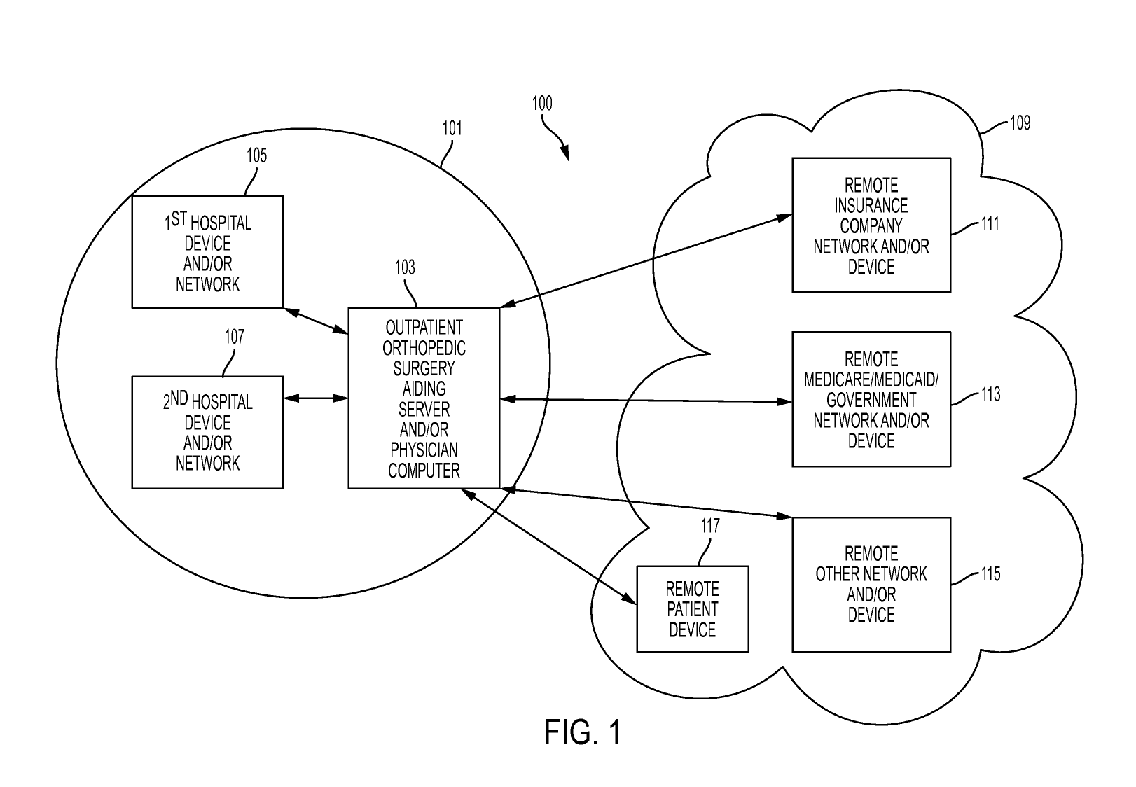

Referring now to FIG. 1, a block diagram illustrating an outpatient orthopedic surgery aiding system 100, including an outpatient orthopedic surgery aiding server 103 is discussed and described. The outpatient orthopedic surgery aiding system 100 includes a physician/hospital network 101 and a remote network 109. In an exemplary embodiment, the physician/hospital network includes the outpatient orthopedic surgery aiding server 103, which may be operated by a physician and/or a group of physicians, and one or more network hospital devices 105, 107. It should be understood that a significant amount of data that is needed by a physician may be available through the hospital devices 105, 107, and as well, the hospital devices 105, 107 may need to communicate with the outpatient orthopedic surgery aiding server 103. The outpatient orthopedic surgery aiding server 103 and the hospital devices 105, 107 may each be communicable with the other over a local area network (LAN), or if enough physician groups and hospitals are interconnected, a wide area network (WAN). Succinctly put, physicians and hospitals typically exchange significant amount of data with each other, particularly where a patient has an established history.

As mentioned above, the outpatient orthopedic surgery aiding server 103 may be operated by a physician or group of physicians who make determinations as to which orthopedic surgery patients may be appropriate for outpatient orthopedic surgery. The outpatient orthopedic surgery aiding server 103 performs the functionality discussed above related to determining whether an orthopedic surgery is appropriate, may be appropriate, or is not appropriate for orthopedic surgery in an outpatient setting. Much of the functionality of the outpatient orthopedic surgery aiding server 103 may be performed autonomously in response to input from remote third party devices such as a remote insurance company device 113, a government operated Medicare/Medicaid device 113, or other remote device 115. It is equally likely that a physician may manually operate the outpatient orthopedic surgery aiding server 103 in response to a request from a patient using a remote patient device 117.

When the outpatient orthopedic surgery aiding server 103 performs the functionality discussed above, the server 103 can transmit information to the remote insurance company device 113, a government operated Medicare/Medicaid device 113, or other remote device 115. Often times, an insurance company or a government health related department will want to know whether a particular patient is appropriate or suitable for orthopedic surgery in an outpatient setting. Thus the outpatient orthopedic surgery aiding server 103 after completing a risk assessment will transmit a determination as whether a patient is suitable for outpatient orthopedic surgery to the remote network 109 and onto the devices 111, 113, 115. From there, it can be determined either automatedly or manually what type of funding, either through insurance or Medicare/Medicaid, will be provided to the orthopedic surgery patient. Specifically, the devices 111, 113, 115 may automatedly or manually determine whether outpatient or inpatient will be funded in consideration of suitability findings of the outpatient orthopedic surgery aiding server 103. The devices 111, 113, 115 may then provide the determination of funding to the physician/hospital network 101 such that the outpatient orthopedic surgery aiding server 103 can store the determination.

It should be noted that this communication arrangement between the outpatient orthopedic surgery aiding server 103 and the remote insurance company device 113, the government operated Medicare/Medicaid device 113, and/or another remote device 115 is a significant improvement in technology over prior art systems. Succinctly put, the single processing path indicated in the transfer of a suitability determination creates a tremendous resource efficiency not achieved by the prior art. In particular, where networked apparatuses communicate with one another to provide information rather than operate independently, as in the prior art, tremendous efficiency of resources is achieved. If an outpatient orthopedic surgery aiding server 103 has to perform orthopedic outpatient suitability functions, and then transfer data in a non-automated manner, transfer time and processing power is significantly impacted.

Each of the outpatient orthopedic surgery aiding server 103, the hospital devices 105, 107, and the remote devices 111, 113, 115, 117 may be viewed as a computer system. The computer systems 103, 105, 107, 111, 113, 115, 117 may communicate each with the other over any network such as the Internet, an intranet, or any other network. Each computer system 103, 105, 107, 111, 113, 115, 117 may be programmed to operate in automated fashion, and may also have an analog or a graphic user interface such as Outlook and Windows such that users can control computer systems 103, 105, 107, 111, 113, 115, 117. Each computer system 103, 105, 107, 111, 113, 115, 117 may include at least a central processing unit (CPU) with data storage such as disk drives, the number and type of which are variable. In each computer system 103, 105, 107, 111, 113, 115, 117 there might be one or more of the following: a floppy disk drive, a hard disk drive, a solid state drive, a CD ROM or digital video disk, or other form of digital recording device.

Each computer system 103, 105, 107, 111, 113, 115, 117 may include one or more displays upon which information may be displayed. Input peripherals, such as a keyboard and/or a pointing device, such as a mouse, may be provided in each computer system 103, 105, 107, 111, 113, 115, 117 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

At this point, the manner in which a patient's identified physiological characteristics are input into the system is discussed. In one embodiment, entry will be performed through an input mechanism by an attending orthopedic surgeon or a member of his staff. This typically would occur by the surgeon or staff member entering the data at a keyboard at the server 103. In other instances, the data representative of the identified physiological characteristics would be entered by the patient himself at the remote patient device 117, and the data would be communicated over the network 109 and 101 to reach the outpatient orthopedic surgery aiding server 103.

As mentioned above, communication between the outpatient orthopedic surgery aiding server 103 and hospital devices 105, 107 may be necessary. This could occur where medical data related to identified physiological characteristics of the orthopedic surgery patient have been previously reported to the various hospitals and/or the staffs thereof and are now maintained on hospital devices 105, 107. The data can be easily communicated from the hospital devices 105, 107 to the outpatient orthopedic surgery aiding server 103 with ease. As with many aspects of this disclosure, the improvement in the technology in the art related to resource efficiency is quite notable.

It should further be noted that when a suitability value has been compared with predetermined standard values in order to determined suitability of an orthopedic surgery patient for outpatient surgery, such a determination can be presented on a display of the outpatient orthopedic surgery aiding server 103. As well the determination can be communicated from the outpatient orthopedic surgery aiding server 103 to any of the other computers 105, 107, 111, 113, 115, 117 for further display on these computers.

Each computer system 103, 105, 107, 111, 113, 115, 117 may interconnect peripherals previously mentioned herein through a bus supported by a bus structure and protocol. The bus may serve as the main source of communication between components of each computer system 103, 105, 107, 111, 113, 115, 117. The bus in each computer system 103, 105, 107, 111, 113, 115, 117 may be connected via an interface.

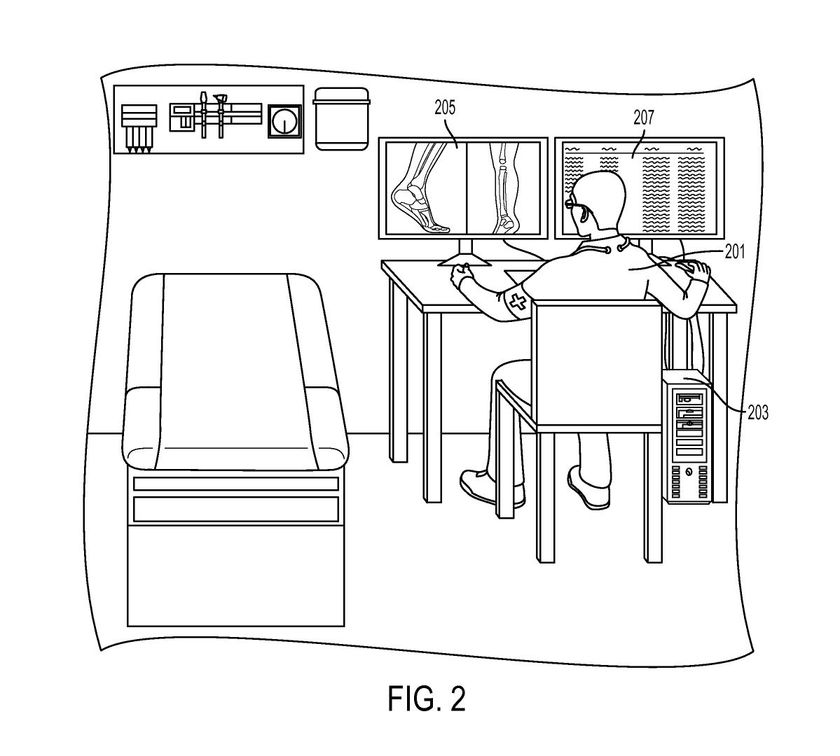

The CPU of each computer system 103, 105, 107, 111, 113, 115, 117 may perform the calculations and logic operations required to execute the functionality of each computer system as described in this disclosure and as illustrated in FIGS. 2-4. The functionality of each computer system 103, 105, 107, 111, 113, 115, 117 may be processed in an automated fashion such that relevant data is processed without user administrator assistance or intervention. Alternatively or additionally, the functionality of each computer system 103, 105, 107, 111, 113, 115, 117 may be processed in a semi-automatic fashion with intervention from a user administrator at one or more of the computer systems 103, 105, 107, 111, 113, 115, 117. Implementing, processing, and executing the functionality of each computer system 103, 105, 107, 111, 113, 115, 117 as described in this disclosure with respect to FIGS. 2-4 is within the purview and scope of one of ordinary skill in the art, and is not discussed in detail herein.

Each computer system 103, 105, 107, 111, 113, 115, 117 may be implemented as a distributed computer system or a single computer. Similarly, each computer system 103, 105, 107, 111, 113, 115, 117 may be a general purpose computer, or a specially programmed special purpose computer. Moreover, processing in each computer system 103, 105, 107, 111, 113, 115, 117 may be controlled by a software program on one or more computer systems or processors, or could even be partially or wholly implemented in hardware. The computer systems 103, 105, 107, 111, 113, 115, 117 used in connection with the functionality described with reference to FIGS. 2-4 may rely on the integration of various components including, as appropriate and/or if desired, hardware and software servers, database engines, and/or other content providers.

Although the computer systems 103, 105, 107, 111, 113, 115, 117 in FIG. 1 are illustrated as being a single computer, each computer system according to one or more embodiments of the invention is optionally suitably equipped with a multitude or combination of processors or storage devices. For example, each computer illustrated in computer systems 103, 105, 107, 111, 113, 115, 117 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system 103, 105, 107, 111, 113, 115, 117 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 103, 105, 107, 111, 113, 115, 117. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more of the computer system 103, 105, 107, 111, 113, 115, 117 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 103, 105, 107, 111, 113, 115, 117 may be connected over the Internet, an intranet, or over a further network. Links to any network may be a dedicated link, a modem over a POTS line, and/or any other method of communicating between computers and/or users.

Each computer system 103, 105, 107, 111, 113, 115, 117 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked.

Turning now to FIG. 2, a diagram illustrating a physician 201 using an outpatient orthopedic surgery aiding server 203 is discussed and described. Specifically, FIG. 2 illustrates the physician 201 viewing a first monitor 205 and a second monitor 207. Both the first monitor 205 and the second monitor 207 are connected to the outpatient orthopedic surgery aiding server 203 through a hard wire connection. It should certainly be clear that any of the peripherals illustrated in FIG. 2 could be connected to the server 203 wirelessly as well. It should also be noted that although two monitors are seen in FIG. 2, it is certainly within the skill of one in the art to include the displayed material on a single screen or viewing area.

FIG. 2 illustrates the idea that the scoring functionality discussed above, related to determining suitability of an orthopedic surgery patient for surgery in an outpatient setting, can be used in conjunction with other medical data (as seen in the monitor 205) in making an outpatient suitability determination. FIG. 2 also illustrates the how the suitability determination functionality, in coordination with the data processing of the other medical data (as seen in the monitor 205) improves resource efficiency in the server 203. These two illustrative principles are discussed further.

As seen in Table 2 above, there are two situations where a patient is considered suitable for outpatient orthopedic surgery based on a first suitability value. The first condition is where the suitability value is less than or equal to a first predetermined standard value (the value being 29 in Table 2). In this situation, it is determined that the patient is appropriate for outpatient surgery. Only under a situation where the physician 201 is aware of an extreme condition based on the x-rays displayed in monitor 205 or some other medical data would the suitability determination be overridden.

The second situation is where the suitability value is greater than the first predetermined standard value (not less than or equal to) and is less than or equal to a second predetermined standard value. In FIG. 2, the second situation arises where the suitability value is greater than or equal to 30 and less than or equal to 59. In this second situation, the orthopedic surgery patient may (or may not) be suitable for outpatient surgery. The physician 201 and the patient can make this decision in consultation, or the physician 201 can singularly make the decision after reviewing medical factors even more closely. Certainly, the exact nature and extent of the injury seen in the x-ray displayed in the monitor 205 will be something the physician 201 will consider.

As mentioned above, FIG. 2 also illustrates the how the suitability determination functionality, in coordination with the data processing of the other medical data (as seen in the monitor 205) improves resource efficiency in the server 203. In the scene depicted in FIG. 2, the physician 201 can make a final determination as to the suitability of the orthopedic surgery patient for outpatient surgery. If this final determination is that a particular patient is suitable for outpatient orthopedic surgery, the physician 201 can initiate a communication through the outpatient orthopedic surgery aiding server 203 such that a communication is transmitted over a network (as seen in FIG. 1). Ultimately, the patient is the recipient of the communication which prompts the patient to thereby schedule an outpatient surgery date. The patient can then, at the prompt, provide a surgery date which is transmitted back to the server 203 under the control of the physician 201 or his staff.

The type of communication discussed above is extremely resource efficient. The server 203 is not constantly querying a user physician 201 or staff for further instructions or information. The server 203 can schedule outpatient surgery with very little processing power or time. Specifically, the automated communication allows the server 203 to execute other programs in the background rather than interact with a user. Succinctly put, the novel and unique server 203 which aids in successful outpatient orthopedic surgery is a major improvement over prior art.

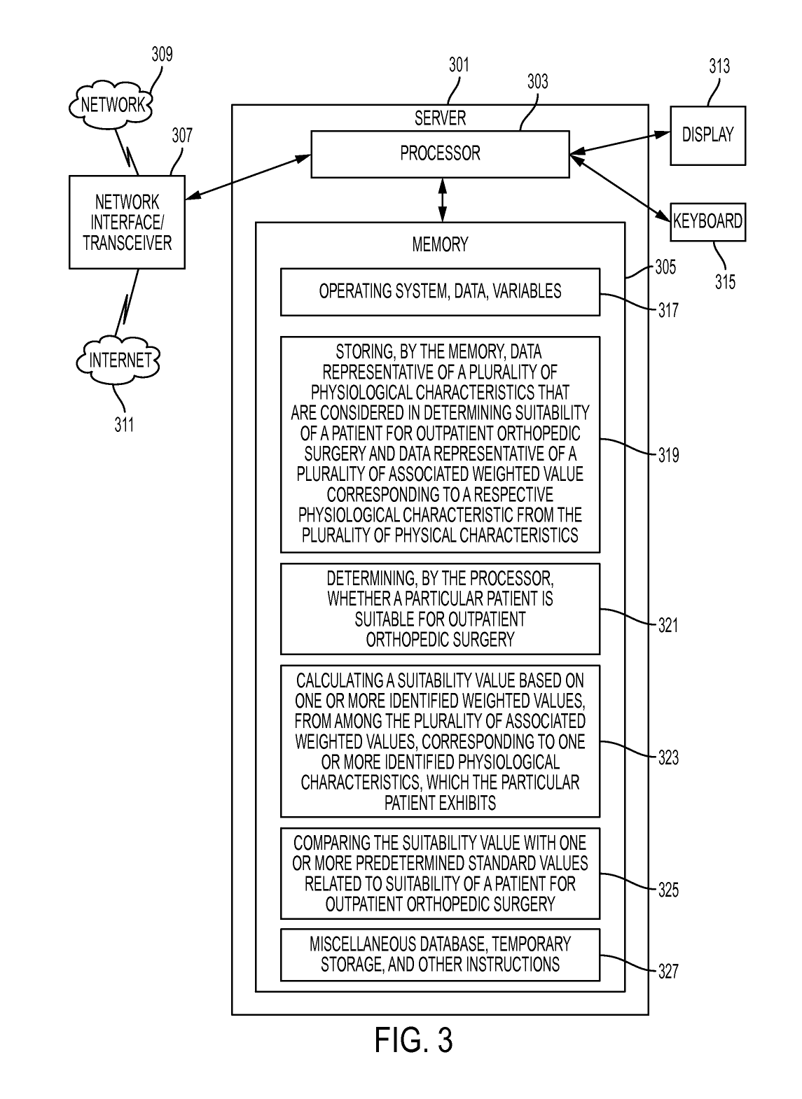

Tuning now to FIG. 3, a block diagram illustrating an outpatient orthopedic surgery aiding server 301 configured to implement outpatient orthopedic surgery aiding functionality is discussed and described. The outpatient orthopedic surgery aiding server 301 may include a transceiver 307, a processor 303, a memory 305, a display mechanism 313, and a keypad and/or touch screen 315. The transceiver 307 may be equipped with a network interface that allows the outpatient orthopedic surgery aiding server 301 to communicate with other devices in a physician/hospital or other network 309 or over the Internet 311. Alternatively, the network interface may be provided in a separate component coupled with the transceiver 307.

The processor 303 may comprise one or more microprocessors and/or one or more digital signal processors. The memory 305 may be coupled to the processor 303 and may comprise a read-only memory (ROM), a random-access memory (RAM), a programmable ROM (PROM), and/or an electrically erasable read-only memory (EEPROM). The memory 305 may include multiple memory locations for storing, among other things, an operating system, data and variables 317 for programs executed by the processor 303.

The computer programs cause the processor 303 to operate in connection with various functions as now described. A storing physiological characteristics function 319 causes the processor 303 to further cause the memory 305 to store data representative of a plurality of physiological characteristics that are considered in determining suitability of a patient for outpatient orthopedic surgery. The storing physiological characteristics function 319 further causes the processor 303 to further cause the memory 305 to store data representative of a plurality of associated weighted values, each associated weighted value corresponding to a respective physiological characteristic from the plurality of physical characteristics.

The determining suitability function 321 causes the processor 303 to determine whether a particular patient is suitable for outpatient orthopedic surgery by performing functions. The calculating suitability function 323 causes the processor 303 to calculate a suitability value based on one or more identified weighted values, from among the plurality of associated weighted values, corresponding to one or more identified physiological characteristics, from among the plurality of physiological characteristics, which the particular patient exhibits. The comparing suitability value function 325 causes the processor 305 to compare the suitability value with one or more predetermined standard values related to suitability of a patient for outpatient orthopedic surgery.

The above described functions stored as computer programs may be stored, for example, in ROM or PROM and may direct the processor 303 in controlling the operation of the outpatient orthopedic surgery aiding server 301. The memory 305 can additionally store a miscellaneous database and temporary storage 327 for storing other data and instructions not specifically mentioned herein.

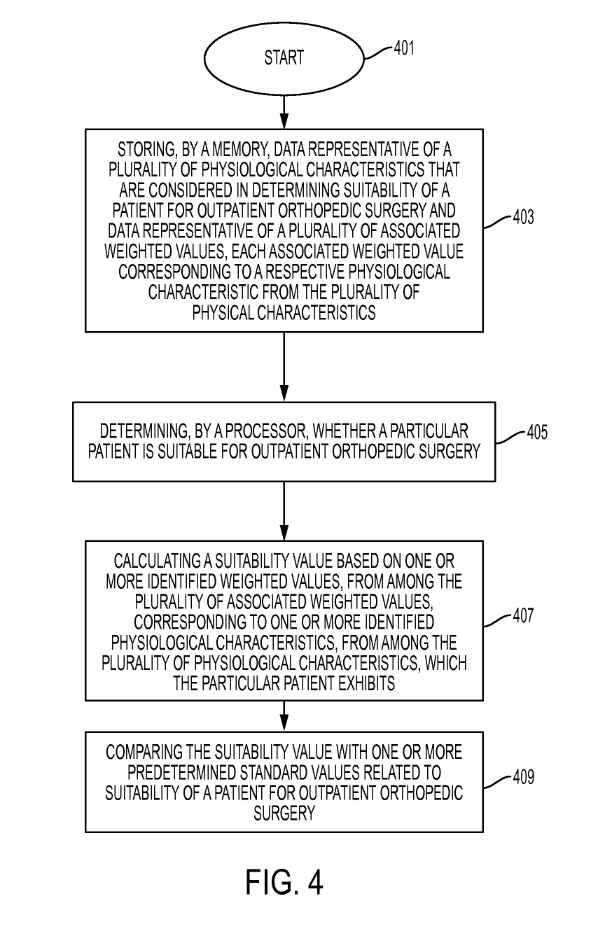

Turning now to FIG. 4, a flow chart illustrating an outpatient orthopedic surgery aiding method is discussed and described. The outpatient orthopedic surgery aiding method is advantageously implemented in an outpatient orthopedic surgery aiding apparatus on a network, the apparatus including a communication interface, a memory, a processor, one or more data inputs, and an output display. When a physician begins considering whether a patient is a candidate for outpatient orthopedic surgery the method begins at 401.

The method comprises storing 403, by the memory, data representative of a plurality of physiological characteristics that are considered in determining suitability of a patient for outpatient orthopedic surgery and data representative of a plurality of associated weighted values. Each associated weighted value corresponds to a respective physiological characteristic from the plurality of physical characteristics. The method further comprises determining 405, by the processor, whether a particular patient is suitable for outpatient orthopedic surgery.

The determining 405 further includes calculating 407 a suitability value based on one or more identified weighted values, from among the plurality of associated weighted values, corresponding to one or more identified physiological characteristics, from among the plurality of physiological characteristics, which the particular patient exhibits. The determining 405 further includes comparing 409 the suitability value with one or more predetermined standard values related to suitability of a patient for outpatient orthopedic surgery.

Ensuring that orthopedic surgery patient is appropriate for outpatient surgery is an important part of safely performing the outpatient surgery. However in addition to the measures discussed above, there are several other considerations that must be taken into account to ensure the safety of the patient.

V. Routine Orders

There are several preoperative and postoperative orders that must be followed to ensure safety.

Routine Preoperative Orders

### IVF

1 Liter NS Bolus

### Pain Control Medications

Tylenol 1000 mg PO (start the day prior to surgery)
Oxycontin 10-20 mg PO
Celebrex 200 mg PO (unless GFR <60)
Lyrica 75 mg PO

Anti-Nausea/GI Prophylaxis
Preoperative dexamethasone (unless diabetic or pre-diabetic)
Scopolamine patch
Ondansetron 4 mg IV/PO
Pepcid 20 mg PO

Itching
Vistaril 25 mg PO

Routine Postoperative Orders/Protocol

### IVF

1 Liter NS bolus per joint in PACU
100 ml/hr NS until 0600 POD#1 if 23 hour observation, or until discharge home if same-day discharge
500 ml NS bolus prn SBP<90. May repeat×1
500 ml NS bolus prn urine output<300 ml in last 8 hours
Foley catheter placement discouraged (must be discontinued by end of surgery and intrathecal narcotic avoided)

### Pain Control

Tylenol 1000 mg PO tid scheduled starting preoperatively the day prior to surgery
Oxycontin 10-20 mg PO q12 scheduled
Celebrex 200 mg po bid (unless contraindicated)
Oxycodone 5-10 mg PO hourly prn mild pain
Oxycodone 10-20 mg PO hourly prn moderate pain
Dilaudid 0.5 mg W q20 minutes prn severe pain

### Anti-Nausea

Preoperative dexamethasone (unless diabetic or pre-diabetic)
Scopolamine patch
Ondansetron 4 mg IV/PO q6 hrs prn nausea
Promethazine 6.25 mg IV/PO q6 hrs prn nausea
Prochlorperazine 5-10 mg IV/PO q6 hrs prn nausea

### Itching

Zyrtec 10 mg daily
Vistaril 25 mg PO q6 hrs prn moderate itching
Benadryl 12.5-25 mg IV/PO q6 hr prn moderate itching
Nubain 2.5-5 mg W q12 hrs prn severe itching

### Prophylaxis

DVT prophylaxis (i.e. Aspirin, Xarelto, etc.)
SCDs while hospitalized
Pepcid 20 mg PO daily (if not already on a PPI or H2 blocker)
Docusate/Senna 50/187 mg 2 tablets PO bid

### Hypoxemia

Wean oxygen to lowest amount or off to keep sats ≧90%

### Laboratory Analysis

Hemoglobin POD#1
BMP (if has renal disease or postoperative oliguria or hypotension)

### Call Orders

SBP<90 after two prn boluses
SBP>180
DBP>100
RR<8 or >20
Post-void residual >300 ml
Significant confusion
Any diarrhea
Oxygen requirement >4L NC to keeps sat≧90%
Chest pain, SOB, abdominal pain/distention

There are also several necessary criteria to be followed for a safe medical discharge.

VI. Medical Discharge

### Criteria

Hemoglobin >9.0 (lower levels require home monitoring)
Sats≧90% on RA
Urinating normally
   Output >300 ml per 8 hrs
   Post-void residual of <300 ml
Taking PO well
   Drinking at least 250 ml per 4 hrs day of discharge

### Discharge Information

Home medicine reconciliation completed
Bowel protocol
Expected abnormalities
   Swelling, bruising, pain, etc.

### Discharge Prescriptions

Narcotic pain medicine
Anti-inflammatory medications (i.e. Celebrex)
DVT prophylaxis
Anti-nausea medication if needed (Ondansetron, Prochlorperazine)
Oral antibiotics if same day discharge to ensure 24 hour antibiotic coverage

### Post-Discharge Call Orders/Discharge Instructions

Any abdominal distention/pain
Decreased urine production
No BM by POD#4
Uncontrolled pain
SOB above baseline
Chest Pain

Physical therapy is a recovery component of any orthopedic surgery. The physical therapy criteria of successful outpatient orthopedic surgery are now provided.

VII. Physical Therapy

Evaluate and Treat the Patient the Evening of Surgery (and POD#1 AM if 23 Hour Overnight Stay)

Discharge Criteria

1. The patient can safely walk 50 feet with the appropriate assistive device. This includes maintaining vitals that are WNL and asymptomatic.

2. If needed the patient is safely able to negotiate steps with the appropriate assistive device. Most patients typically will require at least supervision initially on these steps by a friend or family member.

3. Provided assist as needed from friend or family member, the patient can safely mange getting in to and out of bed as well as complete transfers from bed/chair/toilet.

4. The patient is able to verbalize and comprehend hip precautions during all mobility and ADLs. The patient would benefit from an OT evaluation with the hip equipment prior to discharge if available.

5. Have appropriate assistance at home for at least a day or two post op.

6. Order any durable medical equipment the patient would need on the day of surgery or before.

The outpatient orthopedic patient must maintain a particular schedule for the outcome to be optimal. A typical patient schedule template is thus provided. It should be noted that same day discharge will likely increase as orthopedic surgeons, internal medical physicians, anesthesiologists, and staff refine practices and techniques through experience and quality metric analysis. The quality metrics must be upheld upon shortening the recovery time in the ASC to enact same day discharges, and patient safety must be paramount.

Some scheduling considerations prior to surgery are as follows:

### Office Scheduling and Preoperative Visit

Evaluation by Orthopaedic Surgeon
Surgical scheduling by RN, home health service needs assessment

### Within 30 Days Prior to Surgery

Evaluation and postoperative expectation management by perioperative medical specialist
Informed consent and postoperative expectation management by orthopedic surgeon
Preoperative Teaching Class
   All education reinforces the expectations for next day discharge

### Day Prior to Surgery

Preoperative call by surgeon to reassure patient and reinforce expectations for discharge home the day following surgery

VIII. Example Templates

Same Day Discharge Template
06:30 Arrival and Check-in at ASC (coordinate with ASC Check-in)
06:45 Surgeon/Anesthesiologist/Update H&P/Surgical Site Marking
07:00 Administration of IV antibiotics
07:30 Surgical Incision
08:30 Wound Closure/Transport to PACU
10:00 Initial Evaluation and Treatment by Physical Therapy when PACU Criteria met
14:00 Repeat Evaluation and Treatment by Physical Therapy
15:00 Evaluation by Surgeon and Perioperative Internist
15:00 Repeat IV antibiotic dosing/Discharge home if all medical and therapy criteria met successfully
18:00 Surgical and Medical Physicians call patient at home

### Postoperative Day #1

8:00 Home Health and Physical Therapy Evaluate Knee Patients
12:00 Surgical and Medical Physicians call patient at home

23 Hour Stay Template (Times May Vary)
11:30 Arrival and Check-in at ASC (coordinate with ASC Check-in)
11:45 Care Coordination by Case Management
12:00 Surgeon/Anesthesiologist/Update H&P/Surgical Site Marking
13:00 Surgical Incision
14:00 Wound Closure/Transport to PACU
15:00 Initial Evaluation and Treatment by Physical Therapy when PACU Criteria met
16:00 Evaluation by Surgeon and Perioperative Internist
17:00 PACU Stay Overnight with RN and MD monitoring

### Postoperative Day #1

8:00 Support Person “Coach” Arrives at ASC
8:00 Evaluation by Surgeon and Perioperative Internist
9:00 Evaluation by Physical Therapy
9:30 Care Coordination Finalization by Case Management
9:45 Comprehensive Discharge Instruction Review by RN
10:00 Discharge to Home
17:00 Surgical and Medical Physicians call patient at home

### Postoperative Day #2

8:00 Home Health and Physical Therapy Evaluate Knee Patients
12:00 Surgical and Medical Physicians call patient at home

IX. Program Evaluation/Monitoring and Outcome Metrics

In order to maintain and ensure patient safety, ongoing evaluation of the outpatient orthopedic surgery program is required. Perhaps even more intuitive is that measurements of the program's success must be obtained in order to verify that guidelines and criteria discussed in detail above are correct. Several metrics are now provided for ensuring that the quality of the outpatient orthopedic surgery program is maintained and that the guidelines and criteria used in implementing the program are based on clinical experience.

Surgical/Operating Room Metrics
Surgery start time
Operating Room Exit Time
Surgeon “down time” (if running “jump” or “dual occupancy” rooms)
Surgical Duration/Accuracy
   Actual surgical time versus surgeon booking time
Anesthesia Prep Time
   Defined as In-Room time until patient turnover to ortho team for patient positioning
Ortho Team Prep Time
   Defined as turnover from anesthesia until surgical incision time

Clinical Metrics

### Immediate Postoperative—Complication Monitored Metrics

Medical Complications
   Cardiac-MI
   Pulmonary-unresolved hypoxia
   GU-urinary retention
   GI-ileus
   Endocrine—Blood Glucose control
Surgical Complications
   Neurovascular Injury or deficit
   Blood Loss
   Peri-prosthetic fracture
   Reoperation for any reason

### Postoperative Day 1 Monitored Metrics (if 23 Hour Overnight Stay)

Postoperative Hgb and Blood Loss (Preoperative Hgb-POD#1 Hgb)
Postoperative Creatinine
Postoperative Blood Glucose
Distance ambulated

### Intermediate-Term Complication Monitored Metrics (30 Days)

Falls
UTI
Surgical Site Infection rate
Postoperative hematoma
DVT/PE rate
Blood transfusion
Readmission rate (for any reason including uncontrolled pain)

Program Operational Metrics
Surgical Case Volume & Trends
   Facility
   Surgeon
Length of Stay (measured in hours)
Discharge Disposition
Emergent Transfers with Hospital Admission
Emergent Transfers without Hospital Admission (ER)
Cancellations
Patient Phone Calls to Office Postop Day 1
Patient Visit to Surgeon or Internal Medicine Physician Office Week 1

Financial Metrics
Variable Direct Costs
   Per Surgeon
   Per Facility
   Implant Costs
   Disposable Costs
Reimbursement
   Payer Type
Contribution Margin

Patient Functional Metrics (Preoperative and Postoperative Intervals)
Hips
   WOMAC
   EQ5D
   UCLA lower extremity activity scale
Knees
   Knee Society Score
   EQ5D
   UCLA lower extremity activity scale

Patient Satisfaction
Must be measured for both facility and provider
Overall Patient Satisfaction
Likelihood they would recommend facility/surgeon to others

As mentioned above, ongoing monitoring and evaluation of the outpatient orthopedic surgery program is required. Guidelines for such monitoring and evaluation are now provided.

Monitoring and Program Evaluation

1. Monthly meetings for program metrics (may decrease frequency as program matures, experience is gained and processes is refined) will be attended by all surgeons participating in the program with representation from anesthesia, perioperative internal medicine, and surgical/PACU staff.

2. Quarterly meetings for quality metrics attended by all surgeons participating in the program with representation from anesthesia, perioperative internal medicine, and surgical/PACU staff.

3. Data shown in open and transparent format with all providers and staff at monthly and quarterly meetings.

4. Surgeons and facilities will be able to see their metrics and how they rank with respect to others within their own institution as well as compared to national metrics as they become available.

5. Metrics will be compared to inpatient data to ensure equivalency or superiority in the outpatient setting. Any inferior metric will be evaluated and analyzed for potential etiology and root cause.

6. Action items and process improvement plans will be developed based on best available evidence in conjunction with medical knowledge and experience of the providers and staff.

7. It is strongly recommended that surgeons in the program attend a minimum of 75% of the monthly metric and quality meetings during the first year in the outpatient joint replacement program and 50% of the meetings thereafter.

8. The quality and metric data should be distributed electronically prior to each meeting with an expected confirmation of receipt from all participants.

Guidance for an outpatient orthopedic surgery program has been provided. It should be noted that this disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An apparatus, configured as a node on a network, comprising:
a communication interface;
a memory storing:
data representative of a plurality of physiological characteristics that are considered in determining suitability of a patient for outpatient orthopedic surgery, and
data representative of a plurality of associated weighted values, each associated weighted value corresponding to a respective physiological characteristic from the plurality of physical characteristics; and
a processor determining whether a particular patient is suitable for outpatient orthopedic surgery by performing functions including:
calculating a suitability value based on one or more identified weighted values, from among the plurality of associated weighted values, corresponding to one or more identified physiological characteristics, from among the plurality of physiological characteristics, which the particular patient exhibits, and
comparing the suitability value with one or more predetermined standard values related to suitability of a patient for outpatient orthopedic surgery.

2. The apparatus according to claim 1, wherein
after the determining by the processor whether the particular patient is suitable for outpatient orthopedic surgery, the communication interface communicates data to the network indicative of whether the particular patient is suitable for outpatient orthopedic surgery, and
the apparatus receives over the network, through the communication interface, data indicative that either outpatient orthopedic surgery will be funded or inpatient orthopedic surgery will be funded.

3. The apparatus according to claim 1, further comprising:
one or more data inputs, wherein
the one or more identified physiological characteristics which the particular patient exhibits are further stored as data in the memory after being received either through the one or more data inputs or through the communication interface from a second apparatus configured as a node on the network.

4. The apparatus according to claim 1, wherein
the processor calculating the suitability value includes the processor summing, as a summed suitability value, the one or more identified weighted values corresponding to the one or more identified physiological characteristics.

5. The apparatus according to claim 4, wherein
the processor comparing the suitability value with the one or more predetermined standard values includes:
the processor comparing the summed suitability value with a first predetermined standard value by calculating whether the summed suitability value is less than or equal to the first predetermined standard value, and
when the summed suitability value is not less than or equal to the first predetermined standard value, the processor further comparing the summed suitability value with a second predetermined standard value by calculating whether the summed suitability is less than or equal to the second predetermined standard value, the second predetermined standard value being greater than the first predetermined standard value;
the processor determines that the particular patient is suitable for outpatient orthopedic surgery when the summed suitability value is calculated as less than or equal to the first predetermined standard value;
the processor determines that the particular patient may be suitable for outpatient orthopedic surgery when the summed suitability value is calculated as not less than or equal to the first predetermined standard value and is further calculated as less than or equal to the second predetermined standard value; and
the processor determines that the particular patient is not suitable for outpatient orthopedic surgery when the summed suitability value is calculated as not less than or equal to the first predetermined standard value and is further calculated as not less than or equal to the second predetermined standard value.

6. The apparatus according to claim 3, further comprising:
an output display, wherein:
after the determining by the processor whether the particular patient is suitable for outpatient orthopedic surgery, the output display displays data indicative of whether the particular patient is suitable for outpatient orthopedic surgery

7. The apparatus according to claim 6, wherein
the output display presents the data indicative of whether the particular patient is suitable for outpatient orthopedic surgery on a single screen with other medical data related to the particular patient, and
when it is determined that the particular patient is suitable for outpatient orthopedic surgery and the one or more data inputs receive data indicative that an outpatient orthopedic surgery should be scheduled, the communication interface outputs to the network data indicative that the patient should schedule an outpatient orthopedic surgery.

8. A method, implemented in an apparatus on a network, the apparatus including a communication interface, a memory, a processor, one or more data inputs, and an output display, the method comprising:
storing, by the memory, data representative of a plurality of physiological characteristics that are considered in determining suitability of a patient for outpatient orthopedic surgery and data representative of a plurality of associated weighted values, each associated weighted value corresponding to a respective physiological characteristic from the plurality of physical characteristics; and
determining, by the processor, whether a particular patient is suitable for outpatient orthopedic surgery by:
calculating a suitability value based on one or more identified weighted values, from among the plurality of associated weighted values, corresponding to one or more identified physiological characteristics, from among the plurality of physiological characteristics, which the particular patient exhibits,
comparing the suitability value with one or more predetermined standard values related to suitability of a patient for outpatient orthopedic surgery.

9. The method according to claim 8, further comprising:
after the determining whether the particular patient is suitable for outpatient orthopedic surgery, communicating, by the communication interface, data to the network indicative of whether the particular patient is suitable for outpatient orthopedic surgery; and
receiving over the network, by the communication interface, data indicative that either outpatient orthopedic surgery will be funded or inpatient orthopedic surgery will be funded.

10. The method according to claim 8, further comprising:
storing, by the memory, data indicative of the one or more identified physiological characteristics which the particular patient exhibits after the data is received either through the one or more data inputs or through the communication interface from a second apparatus configured as a node on the network.

11. The method according to claim 8, wherein
calculating the suitability value includes summing, as a summed suitability value, by the processor, the one or more identified weighted values corresponding to the one or more identified physiological characteristics.

12. The method according to claim 11, wherein
comparing the suitability value with one or more predetermined standard values includes:
comparing, by the processor, the summed suitability value with a first predetermined standard value by calculating whether the summed suitability value is less than or equal to the first predetermined standard value, and
when the summed suitability value is not less than or equal to the first predetermined standard value, comparing, by the processor, the summed suitability value with a second predetermined standard value by calculating whether the summed suitability is less than or equal to the second predetermined standard value, the second predetermined standard value being greater than the first predetermined standard value;
determining that the particular patient is suitable for outpatient orthopedic surgery occurs when the summed suitability value is calculated as less than or equal to the first predetermined standard value;
determining that the particular patient may be suitable for outpatient orthopedic surgery occurs when the summed suitability value is calculated as not less than or equal to the first predetermined standard value and is further calculated as less than or equal to the second predetermined standard value; and
determining that the particular patient is not suitable for outpatient orthopedic surgery occurs when the summed suitability value is calculated as not less than or equal to the first predetermined standard value and is further calculated as not less than or equal to the second predetermined standard value.

13. The method according to claim 10, further comprising:
after the determining whether the particular patient is suitable for outpatient orthopedic surgery, displaying by the output display data indicative of whether the particular patient is suitable for outpatient orthopedic surgery

14. The method according to claim 13, further comprising:
displaying, by the output display, the data indicative of whether the particular patient is suitable for outpatient orthopedic surgery on a single screen with other medical data related to the particular patient; and
when it is determined that the particular patient is suitable for outpatient orthopedic surgery and when the one or more data inputs receive data indicative that an outpatient orthopedic surgery should be scheduled, outputting, by the communication interface, data that the patient should schedule an outpatient orthopedic surgery to the network.

15. A non-transitory computer-readable storage medium with instructions stored thereon, that when executed by an apparatus, including a communication interface, a memory, a processor, one or more data inputs, and an output display, cause the apparatus to perform a method comprising:
storing, by the memory, data representative of a plurality of physiological characteristics that are considered in determining suitability of a patient for outpatient orthopedic surgery and data representative of a plurality of associated weighted values, each associated weighted value corresponding to a respective physiological characteristic from the plurality of physical characteristics; and
determining, by the processor, whether a particular patient is suitable for outpatient orthopedic surgery by:
calculating a suitability value based on one or more identified weighted values, from among the plurality of associated weighted values, corresponding to one or more identified physiological characteristics, from among the plurality of physiological characteristics, which the particular patient exhibits,
comparing the suitability value with one or more predetermined standard values related to suitability of a patient for outpatient orthopedic surgery.

16. The non-transitory computer-readable storage medium according to claim 15, wherein the method further comprises:
after the determining whether the particular patient is suitable for outpatient orthopedic surgery, communicating, by the communication interface, data to the network indicative of whether the particular patient is suitable for outpatient orthopedic surgery; and
receiving over the network, by the communication interface, data indicative that either outpatient orthopedic surgery will be funded or inpatient orthopedic surgery will be funded.

17. The non-transitory computer-readable storage medium according to claim 15, wherein the method further comprises:
storing, by the memory, data indicative of the one or more identified physiological characteristics which the particular patient exhibits after the data is received either through the one or more data inputs or through the communication interface from a second apparatus configured as a node on the network.

18. The non-transitory computer-readable storage medium according to claim 15, wherein:
calculating the suitability value includes summing, as a summed suitability value, by the processor, the one or more identified weighted values corresponding to the one or more identified physiological characteristics.

19. The non-transitory computer-readable storage medium according to claim 18, wherein:
comparing the suitability value with one or more predetermined standard values includes:
comparing, by the processor, the summed suitability value with a first predetermined standard value by calculating whether the summed suitability value is less than or equal to the first predetermined standard value, and
when the summed suitability value is not less than or equal to the first predetermined standard value, comparing, by the processor, the summed suitability value with a second predetermined standard value by calculating whether the summed suitability is less than or equal to the second predetermined standard value, the second predetermined standard value being greater than the first predetermined standard value;
determining that the particular patient is suitable for outpatient orthopedic surgery occurs when the summed suitability value is calculated as less than or equal to the first predetermined standard value;
determining that the particular patient may be suitable for outpatient orthopedic surgery occurs when the summed suitability value is calculated as not less than or equal to the first predetermined standard value and is further calculated as less than or equal to the second predetermined standard value; and
determining that the particular patient is not suitable for outpatient orthopedic surgery occurs when the summed suitability value is calculated as not less than or equal to the first predetermined standard value and is further calculated as not less than or equal to the second predetermined standard value.

20. The non-transitory computer-readable storage medium according to claim 17, wherein the method further comprises:
after the determining whether the particular patient is suitable for outpatient orthopedic surgery, displaying by the output display data indicative of whether the particular patient is suitable for outpatient orthopedic surgery

21. The non-transitory computer-readable storage medium according to claim 20, wherein the method further comprises:
displaying, by the output display, the data indicative of whether the particular patient is suitable for outpatient orthopedic surgery on a single screen with other medical data related to the particular patient; and
when it is determined that the particular patient is suitable for outpatient orthopedic surgery and when the one or more data inputs receive data indicative that an outpatient orthopedic surgery should be scheduled, outputting, by the communication interface, data that the patient should schedule an outpatient orthopedic surgery to the network.
